(19) United States
(12) Patent Application Publication
(10) Pub. No.: US 2019/0235217 A1
(43) Pub. Date: Aug. 1, 2019

(54) INFRARED LENS UNIT

(71) Applicant: Sumitomo Electric Industries, Ltd., Oska-shi (JP)

(72) Inventors: Masato Hasegawa, Osaka-shi (JP); Akinori Kahara, Osaka-shi (JP); Ryota Yamaguchi, Osaka-shi (JP)

(73) Assignees: Sumitomo Electric Industries, Ltd., Osaka-shi (JP); Sumitomo Electric Industries, Ltd., Osaka-shi (JP)

(21) Appl. No.: 16/086,070

(22) PCT Filed: Mar. 17, 2017
(86) PCT No.: PCT/JP2017/010950

§ 371 Date: Sep. 18, 2018

(30) Foreign Application Priority Data
Mar. 18, 2016 (JP) 2016-056290

(51) Int. Cl. G02B 13/14; G02B 7/02

(52) U.S. Cl. CPC G02B 13/14; G02B 7/021; G02B 7/028

(57) ABSTRACT

An infrared lens unit according to one embodiment of the present invention includes a lens barrel, and one infrared lens disposed inside the lens barrel. The infrared lens unit further includes a tubular driving member that is disposed between the lens barrel and the infrared lens and that holds the infrared lens directly or by means of a holding member. The linear expansion coefficient of the driving member is different from the linear expansion coefficient of the lens barrel. The object-side part of the driving member is fixed to the lens barrel. The image-side part of the outer periphery of the infrared lens or the holding member is fixed to the image-side part of the driving member.

### TECHNICAL FIELD

The present invention relates to an infrared lens unit.

This application claims the priority based on Japanese Patent Application No. 2016-56290 filed on Mar. 18, 2016, the entire contents of which are incorporated herein by reference.

### BACKGROUND ART

An infrared camera including an infrared lens unit having an infrared lens and an infrared imaging device and capturing an infrared image to generate image data has been used for various purposes. As an example, a night vision system that is mounted on a vehicle, captures images around the vehicle using an infrared camera at night, detects a pedestrian having a possibility of collision, and issues a warning to the driver has been put to practical use.

Thus, the infrared camera mounted on the vehicle may be exposed to relatively high temperature. In the infrared lens, since the refractive index and the like change due to heat and the focal length can be changed, in an application in which the use temperature range is wide as described above, there is a possibility that an image out of focus may be captured.

To solve this problem, there has been proposed an infrared lens unit in which a thermally expanding spacer is disposed between two infrared lenses and that moves the infrared lenses in the direction of the optical axis according to the temperature and compensates for the change in the focal length due to the temperature change (International Publication No. 2010/061604).

### CITATION LIST

### Patent Literature

PTL 1: International Publication No. 2010/061604

### SUMMARY OF INVENTION

In an aspect of the present invention, an infrared lens unit includes a lens barrel and one infrared lens disposed inside the lens barrel. The infrared lens unit further includes a tubular driving member disposed between the lens barrel and the infrared lens and holding the infrared lens either directly or by means of a holding member. The linear expansion coefficient of the driving member is different from the linear expansion coefficient of the lens barrel. The object-side part of the driving member is fixed to the lens barrel. The image-side part of the outer periphery of the infrared lens or the holding member is fixed to the image-side part of the driving member.

### BRIEF DESCRIPTION OF DRAWINGS

FIG. 1 is a schematic cross-sectional view showing an infrared lens unit according to one embodiment of the present invention.

FIG. 2 is a schematic cross-sectional view showing an infrared lens unit according to an embodiment of the present invention different from FIG. 1.

### DESCRIPTION OF EMBODIMENTS

### Problems to be Solved by Present Invention

Although the lens unit disclosed in the above gazette uses two infrared lenses, also in a lens unit using only one infrared lens, it is desirable to compensate for the change in the focal length of the infrared lens due to the temperature change. In this case, one infrared lens of the lens unit disclosed in the above gazette may be omitted, and the other infrared lens may be an infrared lens that can be used alone.

However, in the configuration of the lens unit disclosed in the above gazette, since the infrared lens and the spacer are aligned in the optical axis direction, there is a disadvantage that the length in the optical axis direction of the infrared lens unit is relatively large.

The present invention has been made based on the above-mentioned circumstances, and an object of the present invention is to provide an infrared lens unit whose length in the optical axis direction can be made relatively small.

### Advantageous Effects of Present Invention

The length in the optical axis direction of the infrared lens unit according to one embodiment of the present invention can be made relatively small.

### DESCRIPTION OF EMBODIMENTS OF PRESENT INVENTION

In an aspect of the present invention, an infrared lens unit includes a lens barrel and one infrared lens disposed inside the lens barrel. The infrared lens unit further includes a tubular driving member disposed between the lens barrel and the infrared lens and holding the infrared lens either directly or by means of a holding member. The linear expansion coefficient of the driving member is different from the linear expansion coefficient of the lens barrel. The object-side part of the driving member is fixed to the lens barrel. The image-side part of the outer periphery of the infrared lens or the holding member is fixed to the image-side part of the driving member.

In the infrared lens unit, the image-side part of the outer periphery of the infrared lens or the holding member is fixed to the image-side part of the driving member whose object-side part is fixed to the lens barrel. That is, in the infrared lens unit, the driving member that expands and contracts in the optical axis direction due to the temperature change and moves the infrared lens, and the infrared lens moved by the driving member are disposed so that their positions in the optical axis direction overlap each other. Therefore, the overall length in the optical axis direction of the infrared lens unit can be suppressed to a length substantially equal to the length required for the driving member determined according to the movement amount of the infrared lens in the use temperature range.

The driving member may directly hold the infrared lens, and the infrared lens may have, in the image-side part of the outer periphery thereof, an engaging protruding part that protrudes radially outward and is held by the image-side part of the driving member. Since, as described above, the driving member directly holds the infrared lens, and the infrared lens has, in the image-side part of the outer periphery thereof, an engaging protruding part that protrudes radially outward and is held by the image-side part of the driving member, it is relatively easy to fix the image-side part of the outer periphery of the infrared lens to the image-side part of the driving member.

The driving member may hold the infrared lens by means of a tubular holding member, and the infrared lens may be fixed to the object-side part of the holding member. Since, as described above, the driving member holds the infrared lens by means of a tubular holding member, and the infrared lens is fixed to the object-side part of the holding member, it is possible to dispose the infrared lens on the object side in the optical axis direction in the lens unit. Therefore, since the distance between the lens unit and the imaging device can be made smaller, the size of the infrared camera can be reduced.

It is preferable that the infrared lens unit further include a cap that engages with the object-side part of the lens barrel and covers the object side of the outer peripheral part of the infrared lens, and an annular elastic member that seals between the cap and the infrared lens. Since, as described above, the infrared lens unit further includes a cap that engages with the object-side part of the lens barrel and covers the object side of the outer peripheral part of the infrared lens, and an annular elastic member that seals between the cap and the infrared lens, it is possible to prevent water from entering the inside of the lens barrel from the object side. Therefore, by airtightly fixing the lens barrel or the cap to an opening of a waterproof case, an infrared camera that has waterproofness can be constructed relatively easily.

Here, “linear expansion coefficient” means a value measured in conformity with JIS-Z2285 (2003). In addition, “object-side part” and “image-side part” mean regions in which the distances in the optical axis direction from the object-side end and the image-side end are 30% or less of the total length.

### Details of Embodiments of Present Invention

Hereinafter, embodiments of the infrared lens unit according to the present invention will be described in detail with reference to the drawings.

### First Embodiment

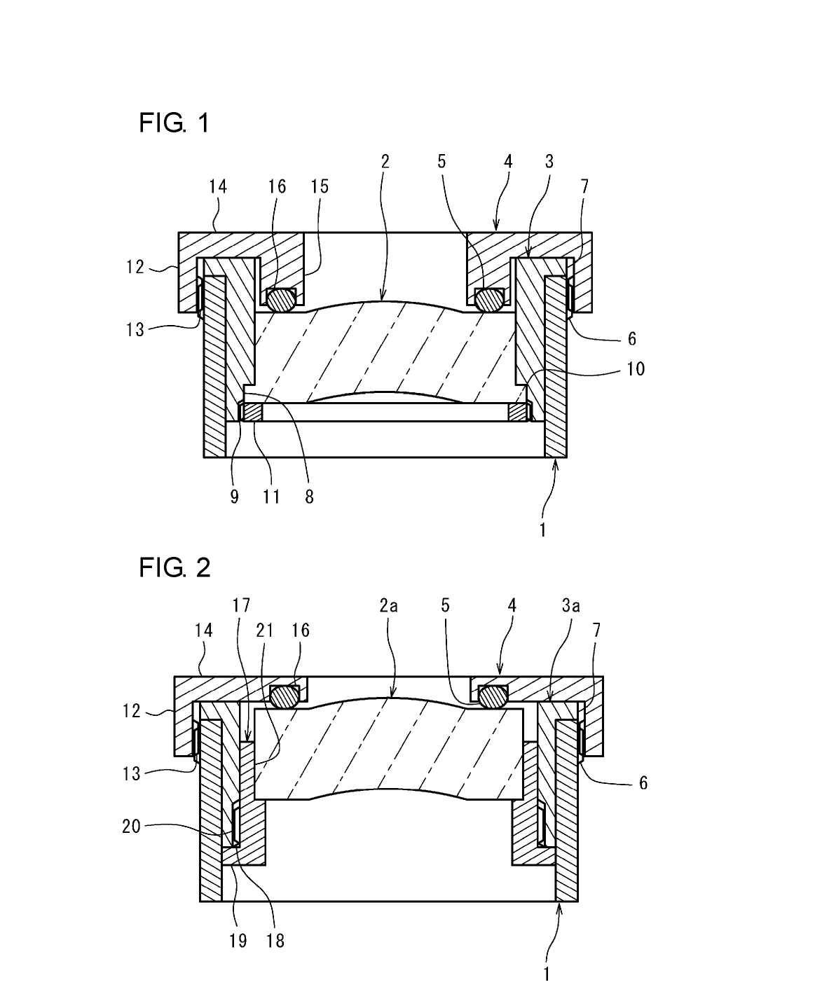

The infrared lens unit shown in FIG. 1 includes a lens barrel 1, one infrared lens 2 disposed inside the lens barrel 1, and a tubular driving member 3 that is disposed between the lens barrel 1 and the infrared lens 2 and directly holds the infrared lens 2. The image-side part of the outer periphery of the infrared lens 2 is fixed to the image-side part of the driving member 3. The object-side part of the driving member 3 is fixed to the object-side part of the lens barrel 1. Therefore, the infrared lens 2 is disposed inside the driving member 3 such that its position in the optical axis direction overlaps with the driving member 3.

Further, the infrared lens unit further includes a cap 4 that engages with the object-side part of the lens barrel 1 and covers the object side of the outer peripheral part (the part outside the optical path) of the infrared lens 2, and an annular elastic member 5 that seals between the cap 4 and the infrared lens.

The lens barrel 1 is formed in a tubular shape, and an external thread 6 to which the cap 4 is screwed is formed on the outer periphery of the object-side part.

The driving member 3 has, in the object-side part thereof, an annular protruding part 7 that protrudes radially outward and is placed on the object-side end face of the lens barrel 1. Further, the driving member 3 has, in the image-side part thereof, an engaging recessed part 8 having an inner diameter larger than that of the other part, and an engaging thread 9 is formed in the inner periphery of the image-side part of the engaging recessed part 8.

The infrared lens 2 is disposed to be fitted to the inside of the driving member 3 and has, in the image-side part of the outer periphery thereof, an engaging protruding part 10 that protrudes radially outward and is engaged with and held by the engaging recessed part 8 of the image-side part of the driving member 3.

Further, the infrared lens unit includes an annular clamp ring 11 that is screwed to the engaging thread 9 of the driving member 3 and presses the engaging protruding part 10 of the infrared lens 2 against the object-side part of the engaging recessed part 8 of the driving member 3. Therefore, the infrared lens 2 can be more reliably driven by expansion and contraction of the driving member 3.

The cap 4 includes an outer tube part 12 disposed outside the lens barrel 1, an internal thread 13 formed inside the outer tube part 12 and screwed to the external thread 6 of the lens barrel 1, a flange part 14 that extends radially inward from the upper end of the outer tube part 12 and that presses the annular protruding part 7 of the driving member 3 against the object-side end face of the lens barrel 1, and an inner tube part 15 that is provided in a radially inner part of the flange part 14 so as to protrude toward the image side and that faces the object-side surface outside the optical path of the infrared lens 2. A holding groove 16 in which the elastic member 5 is fitted is formed in the image-side end face of the inner tube part 15 facing the infrared lens 2.

### <Lens Barrel>

As the material of the lens barrel 1, a metal or resin having light-shielding property, relatively high strength, and excellent workability can be suitably used. Metals forming the lens barrel 1 include aluminum, aluminum alloy, stainless steel, iron, magnesium, brass, and titanium. In particular, the lens barrel 1 is preferably formed of a metal having a passivation film. Specific examples of the metal having a passivation film include aluminum subjected to alumite treatment (anodizing treatment) on its surface. By forming the lens barrel 1 out of a metal having a passivation film, the weather resistance of the lens barrel 1 can be improved.

As the main component of the resin forming the lens barrel 1, polyethylene, polypropylene, ABS resin, polyvinyl chloride, polyethylene terephthalate, polytetrafluoroethylene, polycarbonate, polybutylene terephthalate, polyetherimide, polyether ether ketone, polyamide-imide, polyphenylene sulfide, modified polyphenylene ether, polyvinylidene fluoride, tetrafluoroethylene/hexafluoropropylene copolymer, tetrafluoroethylene/ethylene copolymer, tetrafluoroethylene/perfluoroalkyl vinyl ether copolymer, polychlorotrifluoroethylene and the like can be used. The resin forming the lens barrel 1 may contain, for example, a pigment that imparts light-shielding property and various additives. “Main component” means a component having the largest mass content.

As the material of the lens barrel 1, one having a desired linear expansion coefficient is selected from among them.

### <Infrared Lens>

The infrared lens 2 is formed of a material transmitting infrared rays and has a three-dimensional shape for refracting and focusing infrared rays from the object.

As the main component of the infrared lens 2, any material that transmits infrared rays may be used. For example, a dielectric such as zinc sulfide (ZnS), zinc selenide (ZnSe), magnesium fluoride (MgF₂), sodium chloride (NaCl), potassium chloride (KCl), lithium fluoride (LiF), silicon oxide (SiO₂), calcium fluoride (CaF₂), or barium fluoride (BaF₂), or a semiconductor such as silicon or germanium can be used. Among them, zinc sulfide, which has a relatively high infrared transmittance, is preferable as the main component of the infrared lens 2.

In the case where the infrared lens 2 contains zinc sulfide as the main component, the infrared lens 2 may be formed by chemical vapor deposition (CVD), but by forming it by sintering zinc sulfide powder, which is relatively inexpensive, the manufacturing cost can be suppressed. That is, it is preferable that the infrared lens 2 be a sintered body of a material containing zinc sulfide as the main component. In other words, as the main component of the infrared lens 2, a sintered body of zinc sulfide is preferable.

The infrared lens 2 that is mainly composed of a sintered body of zinc sulfide can be formed by a method including a step of molding a zinc sulfide powder, a step of pre-sintering the molded body, and a step of pressure-sintering the pre-sintered body.

As the zinc sulfide powder forming a sintered body of zinc sulfide, it is preferable to use one having an average particle diameter of 1 μm or more and 3 μm or less and a purity of 95% by mass or more. Such a zinc sulfide powder can be obtained by a known powder synthesis method such as a coprecipitation method. The “average particle diameter” is the particle diameter at which the volume integrated value is 50% in the particle diameter distribution measured by the laser diffraction method.

In the molding step, a compact having a rough shape conforming to the optical component to be finally obtained is formed by press molding using a mold. The mold is formed of a hard material such as cemented carbide or tool steel. Further, this molding step can be carried out using, for example, a uniaxial pressing machine.

In the pre-sintering step, the molded body produced in the molding step is heated, for example, under a vacuum atmosphere of 30 Pa or less or under an inert atmosphere such as nitrogen gas at atmospheric pressure. The pre-sintering temperature can be 500° C. or more and 1000° C. or less, and the pre-sintering time (holding time of the pre-sintering temperature) can be 0.5 hour or more and 15 hours or less. The pre-sintered body obtained in this pre-sintering step has a relative density of 55% or more and 80% or less.

In the pressure-sintering step, a sintered body having a desired shape is obtained by heating the pre-sintered body while pressing it with a press mold. Specifically, as the press mold, for example, a pair of molds (upper mold and lower mold) formed of glassy carbon and having a mirror-polished restrained surface (cavity) can be used. The pressure-sintering temperature is preferably 550° C. or more and 1200° C. or less. The sintering pressure is preferably 10 MPa or more and 300 MPa or less. The sintering time is preferably 1 minute or more and 60 minutes or less.

The sintered body obtained in this pressure-sintering step may be used as it is as the infrared lens 2, but finishing processing such as polishing of the incident surface and the emitting surface may be performed as required.

Further, the infrared lens 2 may have, on the object-side surface thereof, various functional layers, such as a protective layer for improving scratch resistance, a sealing layer for preventing ingress of water molecules, and an antireflection layer for preventing reflection of light in the use wavelength band.

### <Driving Member>

The driving member 3 is formed of a material having a linear expansion coefficient different from that of the lens barrel 1. Therefore, the lens barrel 1 and the driving member 3 expand and contract in the optical axis direction at different ratios in accordance with the change in the ambient temperature. As a result, the infrared lens 2 moves relative to the image-side part of the lens barrel 1 in the optical axis direction. More specifically, when the focal length of the infrared lens 2 decreases due to the temperature rise, the driving member 3 is formed of a material whose linear expansion coefficient is higher than that of the lens barrel 1, moves the infrared lens 2 to the image side when the temperature rises, and moves the infrared lens 2 to the object side when the temperature decreases.

The infrared lens unit is used with the image-side end of the lens barrel 1 fixed, and the lengths in the optical axis direction of the lens barrel 1 and the driving member 3 are determined such that the change in the refractive index of the infrared lens 2 caused by the temperature change and the increase or decrease in the focal length due to the distortion of the shape can be canceled out by the relative movement of the infrared lens 2 with respect to the lens barrel 1 in the optical axis direction caused by the difference in linear expansion coefficient between the lens barrel 1 and the driving member 3.

As the material of the driving member 3, one having a desired linear expansion coefficient different from that of the lens barrel 1 is used from those enumerated as the material of the lens barrel 1.

### <Cap>

The internal thread 13 of the cap 4 is screwed onto the external thread 6 of the lens barrel 1, and thereby the annular protruding part 7 of the driving member 3 is pressed against and fixed to the object-side end face of the lens barrel 1.

The cap 4 is designed such that the image-side end face of the inner tube part 15 has a certain clearance between itself and the opposite object-side surface of the infrared lens 2 at room temperature (for example, 20° C.). The clearance between the inner tube part 15 and the infrared lens 2 can be, for example, 0.05 mm or more and 1 mm or less.

As the material of the cap 4, a metal having relatively high strength and excellent workability can be used. Metals forming the cap 4 include aluminum, aluminum alloy, and stainless steel. In particular, the cap 4 is preferably formed of a metal having a passivation film. Specific examples of the metal having a passivation film include aluminum subjected to alumite treatment (anodizing treatment) on its surface. By forming the cap 4 out of a metal having a passivation film, the weather resistance of the cap 4 can be improved.

### <Elastic Member>

As the elastic member 5, for example, an O-ring, one obtained by annularly cutting out a sheet material, or the like can be used. That is, the cross-sectional shape of the elastic member 5 is not particularly limited. As the O-ring, for example, one in conformity with JIS-B2401 (2012) can be used.

As the main component of the elastic member 5, for example, nitrile rubber (NBR), fluororubber (FKM), fluorosilicone rubber (FVMQ), ethylene-propylene rubber (EPDM), styrene-butadiene rubber (SBR), silicone rubber (VMQ), acrylic rubber (ACM), and hydrogenated nitrile rubber (HNBR) can be used, among which silicone rubber, fluororubber, acrylic rubber, and hydrogenated nitrile rubber, which are excellent in heat resistance, are preferable, and silicone rubber, which is excellent in cold resistance, is particularly preferable.

The lower limit of the average thickness in the optical axis direction of the elastic member 5 (the average value of values obtained by dividing the cross-sectional area by the maximum width) in the no-load state (before being incorporated into the infrared lens unit) is preferably 5 times, more preferably 10 times the designed movement amount of the infrared lens 2 in the optical axis direction. On the other hand, the upper limit of the average thickness of the elastic member 5 in the no-load state is preferably 500 times, more preferably 100 times the designed movement amount of the infrared lens 2 in the optical axis direction. When the average thickness of the elastic member 5 in the no-load state is less than the lower limit, sealing of the gap between the infrared lens 2 and the cap 4 may be unreliable. Conversely, when the average thickness of the elastic member 5 in the no-load state exceeds the upper limit, the length of the infrared lens unit in the optical axis direction may be unnecessarily large.

The lower limit of the average width of the elastic member 5 (the average value of values obtained by dividing the cross-sectional area by the maximum thickness in the optical axis direction) in the no-load state is preferably 1/30, more preferably 1/20 of the average diameter of the infrared lens 2 (the outer peripheral surface not including the engaging protruding part 10). On the other hand, the upper limit of the average width of the elastic member 5 in the no-load state is preferably ⅕, more preferably ⅛ of the average diameter of the infrared lens 2. When the average width of the elastic member 5 in the no-load state is less than the lower limit, sealing of the gap between the infrared lens 2 and the cap 4 may be unreliable. Conversely, when the average width of the elastic member 5 in the no-load state exceeds the upper limit, the size in the direction perpendicular to the optical axis of the infrared lens unit may be unnecessarily large.

The lower limit of the maximum thickness in the optical axis direction of the elastic member 5 in the infrared lens unit at 20° C. is preferably 60%, more preferably 70% of the maximum thickness in the optical axis direction of the elastic member 5 in the no load state. On the other hand, the upper limit of the maximum thickness of the elastic member 5 in the infrared lens unit at 20° C. is preferably 95%, more preferably 90% of the maximum thickness of the elastic member 5 in the no-load state. When the maximum thickness of the elastic member 5 in the infrared lens unit at 20° C. is less than the lower limit, the elastic member 5 may be easily broken. Conversely, when the maximum thickness of the elastic member 5 in the infrared lens unit at 20° C. exceeds the upper limit, there is a possibility that the gap between the infrared lens 2 and the cap 4 cannot be sealed when the infrared lens 2 moves to the image side due to the temperature change.

### <Advantages>

Since, in the infrared lens unit, the engaging protruding part 10 of the image-side part of the infrared lens 2 is fixed to the engaging recessed part 8 of the image-side part of the driving member 3, the infrared lens 2 is disposed inside the driving member 3, and hardly protrudes toward the image-side. Therefore, the infrared lens unit has a relatively small length in the optical axis direction, and the distance from the infrared lens 2 to the imaging device can be easily secured.

Further, since the infrared lens unit includes the cap 4 and the elastic member 5, it is possible to prevent water from entering the lens barrel 1 from the object side. Therefore, by using the infrared lens unit, it is possible to constitute an infrared camera having waterproofness relatively easily.

### Second Embodiment

The infrared lens unit shown in FIG. 2 includes a lens barrel 1, an infrared lens 2a disposed inside the lens barrel 1, a tubular driving member 3a disposed between the lens barrel 1 and the infrared lens 2a, and a tubular holding member 17 held by the driving member 3a. The infrared lens 2a is fixed to the object-side part of the holding member 17. The image-side part of the holding member 17 is fixed to the image-side part of the driving member 3a. That is, the driving member 3a holds the infrared lens 2a by means of the holding member 17. The object-side part of the driving member 3a is fixed to the object-side part of the lens barrel 1. Therefore, the infrared lens 2a and the holding member 17 are disposed inside the driving member 3a such that their positions in the optical axis direction overlap with the driving member 3a.

Further, the infrared lens unit of FIG. 2 further includes a cap 4 that engages with the object-side part of the lens barrel 1 and covers the object side of the outer peripheral part (the part outside the optical path) of the infrared lens 2a, and an annular elastic member 5 that seals between the cap 4 and the infrared lens 2a.

For the infrared lens unit of FIG. 2, the same reference numerals are given to the same constituent elements as the constituent elements of the infrared lens unit of FIG. 1, and redundant description thereof will be omitted.

The driving member 3a has, in the object-side part thereof, an annular protruding part 7 that protrudes radially outward and is placed on the object-side end face of the lens barrel 1, and an connection internal thread 18 formed in the inner peripheral surface of the image-side part.

The holding member 17 has an annular protruding part 19 that protrudes radially outward from the image-side part and is in contact with the image-side end face of the driving member 3a, and a connection external thread 20 that is formed on the outer peripheral surface so as to be adjacent to the annular protruding part 19 and is screwed to the connection internal thread 18 of the driving member 3a. Further, the holding member 17 has, in the object-side part thereof, an engaging recessed part 21 having an inner diameter larger than that of the other part.

The infrared lens 2a is disposed to be fitted to the inside of the holding member 17, and is pressed by the elastic member 5 against the image-side end of the engaging recessed part 21.

### <Holding Member>

The holding member 17 is formed of a material having a linear expansion coefficient different from that of the driving member 3a, preferably a material having a relatively low linear expansion coefficient.

The holding member 17 offsets the infrared lens 2 from the image-side part of the driving member 3a toward the object side. Accordingly, since the infrared lens unit can be disposed closer to the imaging device, the size of the infrared camera can be reduced.

### Other Embodiments

It should be considered that embodiments disclosed above are examples in all respects and are not restrictive. The scope of the present invention is not limited to the configurations of the above embodiments but is defined by the claims, and it is intended that all modifications within meaning and scope equivalent to the claims are included.

When the lens unit is not required to be waterproof, the elastic member can be omitted, and the cap can also be omitted.

In the lens unit, the method for fixing between the respective constituent elements is not limited to the above embodiments, and other methods such as an adhesive, a screw, and a retaining ring (fitted in an annular groove formed in the engaging recessed part, for example) may be used.

1. An infrared lens unit comprising a lens barrel and one infrared lens disposed inside the lens barrel,
the infrared lens unit further comprising a tubular driving member disposed between the lens barrel and the infrared lens and holding the infrared lens either directly or by means of a holding member,
wherein a linear expansion coefficient of the driving member is different from a linear expansion coefficient of the lens barrel,
wherein an object-side part of the driving member is fixed to the lens barrel, and
wherein an image-side part of the outer periphery of the infrared lens or the holding member is fixed to an image-side part of the driving member.

2. The infrared lens unit according to claim 1,
wherein the driving member directly holds the infrared lens, and
wherein the infrared lens has, in the image-side part of the outer periphery thereof, an engaging protruding part that protrudes radially outward and is held by the image-side part of the driving member.

3. The infrared lens unit according to claim 1,
wherein the driving member holds the infrared lens by means of a tubular holding member, and
wherein the infrared lens is fixed to an object-side part of the holding member.

4. The infrared lens unit according to claim 1, further comprising
a cap that engages with an object-side part of the lens barrel and covers an object side of the outer peripheral part of the infrared lens, and
an annular elastic member that seals between the cap and the infrared lens.

5. The infrared lens unit according to claim 2, further comprising
a cap that engages with an object-side part of the lens barrel and covers an object side of the outer peripheral part of the infrared lens, and
an annular elastic member that seals between the cap and the infrared lens.

6. The infrared lens unit according to claim 3, further comprising
a cap that engages with an object-side part of the lens barrel and covers an object side of the outer peripheral part of the infrared lens, and
an annular elastic member that seals between the cap and the infrared lens.
